(19) United States
(12) Patent Application Publication
(10) Pub. No.: US 2012/0295671 A1
(43) Pub. Date: Nov. 22, 2012

(54) SOLAR POWERED WIRELESS SPEAKERPHONE WITH POWER STORAGE FOR CHARGING EXTERNAL DEVICES

(75) Inventors: Roger Alves, Oxnard, CA (US); Mark Larson, Oxnard, CA (US)

(73) Assignee: SCOSCHE INDUSTRIES, INC., Oxnard, CA (US)

(21) Appl. No.: 13/110,191

(22) Filed: May 18, 2011

(51) Int. Cl. H04W 88/02

(52) U.S. Cl. 455/573

(57) ABSTRACT

A portable device includes a wireless communications module configured to communicate with a communication device, a rechargeable energy storage device coupled to the wireless communications module, a solar power cell coupled to the rechargeable energy storage device configured to charge the rechargeable energy storage device and a port coupled to the rechargeable energy storage device configured to provide energy to charge an external device via the port.

### BACKGROUND

1. Field

The present disclosure relates generally to solar powered wireless communication systems and methods, and more particularly to solar powered speakerphone devices enabled to supply stored power to external devices.

2. Background

Increasingly, rechargeable personal consumer electronic products are standardizing on a five volt charging system, typically limited to several hundred milliamperes of current through a USB cable, using standard, mini- and micro-USB connectors between the device and the power charging source. Bluetooth™ headsets and hands-free speakerphones, e-readers, cell phones, personal digital assistants and laptop computer notebooks are examples of such products that may be recharged from an external power supply.

Additionally, some products are appearing in which the capability to recharge from solar power cells is being included in the hardware.

### SUMMARY

In one aspect of the disclosure, a portable device includes a wireless communications module configured to communicate with a network via a network access point. A rechargeable power storage device is coupled to the wireless communications module. A solar power cell coupled to the rechargeable power storage device is configured to charge the rechargeable power storage device. A port coupled to the rechargeable power storage device is configured to provide power to charge an external device.

In another aspect of the disclosure, a portable device includes a means for communicating wirelessly to an access point of a communication network, a means for converting light energy to stored electrical power to operate the communicating means, and a port means for supplying the stored electrical energy to charge external devices.

In another aspect of the disclosure, a method of charging a device includes connecting the device to a portable device, wherein the portable device includes a solar cell for conversion of light energy to electrical energy, a rechargeable power storage device including at least one of a battery and a capacitor for storing the electrical energy, a port for connecting the rechargeable power storage device to the device to provide the stored electrical energy to the device, and a wireless communications module powered by the rechargeable power storage configured to communicate with a network via a network access point. The method includes providing power from the rechargeable power storage device to the device via the port.

### BRIEF DESCRIPTION OF THE DRAWINGS

FIG. 1 is a conceptual front illustration of an embodiment of a mobile speakerphone/solar charger device in accordance with the disclosure.

FIG. 2 is a conceptual configuration of subsystems of the mobile speakerphone/solar charger of FIG. 1.

FIG. 3 is conceptual rear illustration of the mobile speakerphone/solar charger device of FIG. 1.

FIG. 4 is a conceptual first side illustration of the mobile speakerphone/solar charger solar charger device of FIG. 1.

FIG. 5 is a conceptual second side illustration of the mobile speakerphone/solar charger solar charger device of FIG. 1.

FIG. 6A is a conceptual illustration of a side view of a case in accordance with the disclosure to hold the speakerphone/solar charger of FIG. 1.

FIG. 6B is a conceptual illustration of a rear view of the case of FIG. 6A holding the speakerphone/solar charger of FIG. 1.

### DETAILED DESCRIPTION

The present disclosure describes an apparatus more fully hereinafter with reference to the accompanying drawings, in which various aspects of a solar rechargeable portable speakerphone enabled to supply stored power to external devices are presented. This disclosure, however, may be embodied in many different forms and should not be construed as limited by the various aspects of the device presented herein. The detailed description of the solar rechargeable speakerphone is provided below so that this disclosure will be thorough and complete, and will fully convey the scope of the present disclosure to those skilled in the art.

The detailed description may include specific details for illustrating various aspects of a solar rechargeable portable speakerphone enabled to supply stored power to external devices. However, it will be apparent to those skilled in the art that the disclosure may be practiced without these specific details. In some instances, well known elements may be shown in block diagram form, or omitted, to avoid obscuring the inventive concepts presented throughout this disclosure.

By way of example, various aspects of a solar rechargeable portable speakerphone enabled to supply stored power to external devices may be illustrated by describing components that are coupled, attached or connected together. However, the disclosure, while described in terms of a USB cable assembly, may be practiced with other cable and connector standards and formats. As used herein, the terms “coupled”, “attached”, and “connected” may be used to indicate either a direct connection between two components or, where appropriate, an indirect connection to one another through intervening or intermediate components. In contrast, when a component is referred to as being “directly coupled”, “directly attached” or “directly connected” to another component, there are no intervening elements present.

Relative terms such as “lower” or “bottom” and “upper” or “top” may be used herein to describe one element's relationship to another element illustrated in the drawings. It will be understood that relative terms are intended to encompass different orientations of a USB cable assembly in addition to the orientation depicted in the drawings. By way of example, if a solar rechargeable portable speakerphone enabled to supply stored power to external devices in the drawings is turned over, elements described as being on the “bottom” side of the other elements would then be oriented on the “top” side of the other elements. The term “bottom” can therefore encompass both an orientation of “bottom” and “top” depending on the particular orientation of the apparatus.

Various aspects of a solar rechargeable portable speakerphone enabled to supply stored power to external devices may be illustrated with reference to one or more exemplary embodiments. As used herein, the term “exemplary” means “serving as an example, instance, or illustration,” and should not necessarily be construed as preferred or advantageous over other embodiments of a solar rechargeable portable speakerphone enabled to supply stored power to external devices disclosed herein.

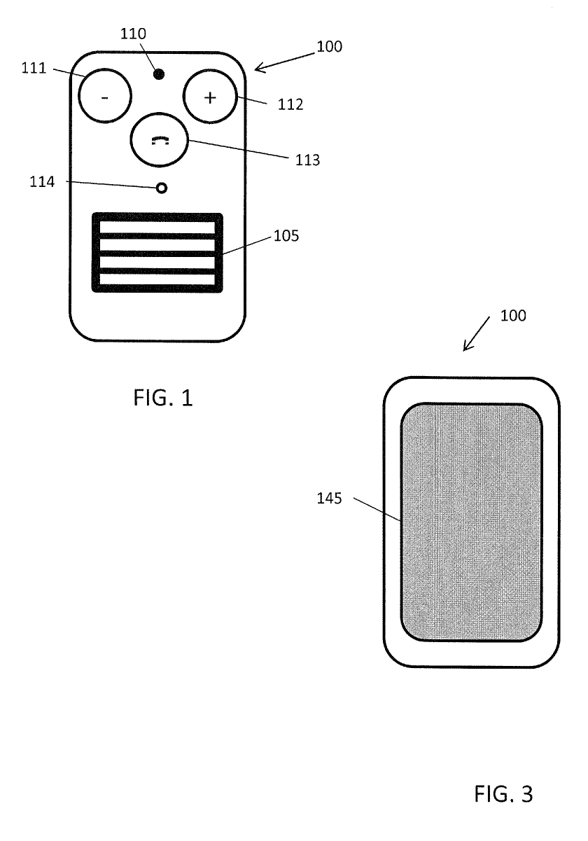

FIG. 1 illustrates a front view of an embodiment of a wireless speakerphone 100 in accordance with the disclosure. The speakerphone 100 includes the standard components and functionality conventionally found in a wireless speakerphone paired for communication with a node having access to a communications network. For example, the speakerphone 100 may be compatible with wireless Bluetooth™ communications with a cell phone, which in turn, is capable of communication over a wireless telephony network. Additionally, the speakerphone 100 may be paired with other devices provided with Bluetooth™ capability to enable use of the speaker and/or the microphone in the speakerphone.

The speakerphone 100 may have features usual for operation, including a speaker 105, a microphone, 110, volume control buttons 111 (−) and 112 (+), a a status indicator light 114, and a call initiate/answer/end button 113, as shown in the front view in FIG. 1. Additional features, shown in other views of the speakerphone 100 are described below.

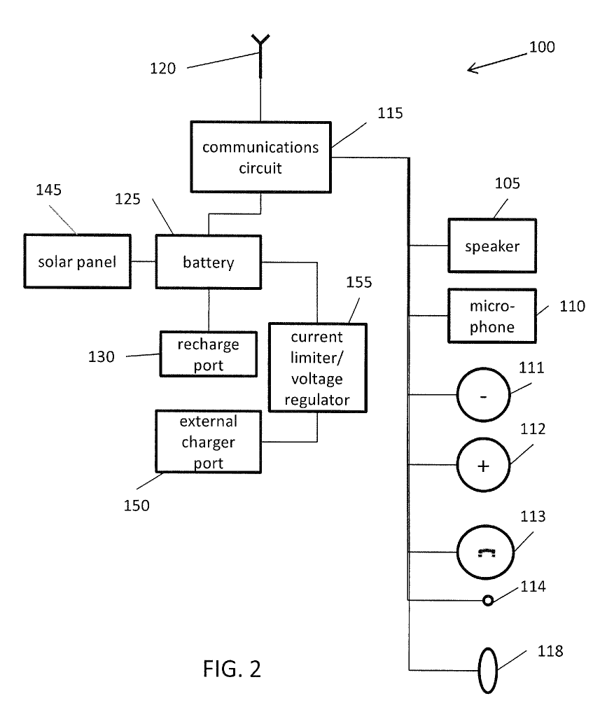

As shown in FIG. 2, the speakerphone 100 includes various subsystems that include a communications circuit 115 coupled to an antenna 120 and a battery 125 (or other means of charge storage, e.g., a capacitor). The communications circuit 115 may be further coupled to the speaker 105, microphone 110, volume control buttons “−” 111 and “+” 112, call start/stop button 113, the status light 114, and a mode button 118 that will be further described herein.

The speakerphone 100 includes a connector port 130 for recharging the battery 125 from, for example, an automobile 12-volt output jack via a vehicle charging adaptor (not shown) or other electrical source as an alternative to light or solar power. Typical vehicle charging adaptors are common in the art of recharging portable electronic devices such as the speakerphone 100, in which a 12 volt DC car battery voltage is converted to a 5 volt DC level that is generally a standard voltage for electronic devices such as the speakerphone 100, where a USB type connector is conventionally used. Converters for converting 120 volt AC to 5 volt DC are also common in the art of recharging portable electronic devices. The connector type for the connector port 130 may be a mini- or micro-USB connector, which may be typical for input ports to portable devices.

In addition, as shown in FIGS. 2 and 3, the speakerphone 100 may also have a solar panel 145 coupled to the battery 125 to charge up the battery 125 in addition to the vehicle charging adaptor or voltage converter. In FIG. 3, the solar panel 145 is located on a rear side of the speakerphone 100, opposite the side illustrated in FIG. 1. As shown in FIG. 2, the speakerphone 100 may be further equipped with a current limiter 155 between the battery and the port 150 to prevent damage to either or both the speakerphone 100 and the external device being charged.

Furthermore, as shown in FIG. 2, the speakerphone may also have an output port 150 to enable the battery 125 to supply energy to charge an external device, such as a cell phone, a digital music player, portable computer, and any such similar portable device that operates on a standard voltage for battery operated rechargeable devices. The port 150 may be a standard USB port, in which case it is advantageous to supply 5 volts DC, which is a standard voltage used to power portable devices via USB. Many portable devices may connect to a computer USB port via a cable, where the device itself may connect to the cable via a mini- or micro-USB connector. Therefore, in an embodiment, the speakerphone 100 may have a standard USB connector port for port 150, which may typically signify that it is an output port.

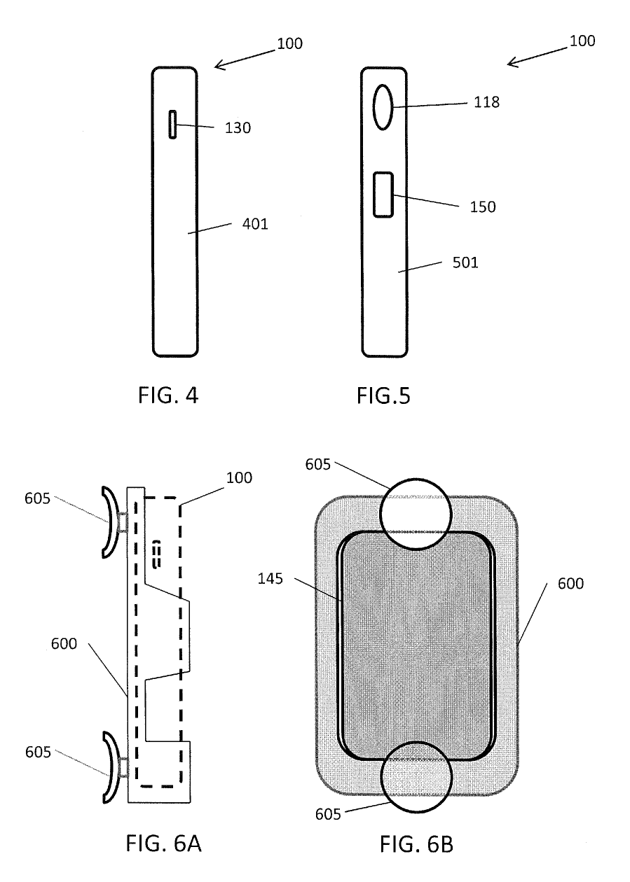

As shown in FIG. 4, the connector port 130 may be located on a first side 401 of the speakerphone 100. However, the location shown is optional and other locations may be selected.

Referring to FIG. 5, the port 150 may be located on the second side 501. However, other locations may be selected. Also shown in FIG. 5, a mode button 118 to switch between various functions, such as call initiating, call ending, call answer, etc., may be located on the second side 501. As shown in FIG. 5, the mode button 118 is located on a second side 501 of the speakerphone 100. However, other locations may be selected.

The speakerphone 100 may be conveniently mounted to a window with the solar panels facing outwardly towards sunlight. When used in an automobile, for example, the speakerphone 100 may be placed on the windshield or a window. However, the speakerphone 100 may charge with the solar panels 145 facing any sufficiently bright source of light. When positioned on a window or sunroof, for example, to optimize exposure to sunlight, the speakerphone 100 may include a case 600 that may include one or more suction cups 605, or equivalent, as shown in FIGS. 6A and 6B, or other forms of attachment to mount and position the solar panel 145 facing toward the sun or a light source, with the speaker 105, microphone 110, various control buttons and indicator light 114 facing in the opposite direction for easy access by a user.

It may be appreciated that the speakerphone 100 provides, in addition to typical wireless services such as Bluetooth™ communications with other devices such as base phone, wireless phone, etc., also serves as a source of power to other battery powered devices, where the voltage requirements are substantially the same. Thus, a backup source of power, such as for emergencies, is available to the user for communications and other applications.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A portable device comprising:
means for communicating wirelessly to a communication device;
means for converting light energy to electrical energy to provide power to the communicating means;
means for storing the electrical energy; and
a port means for supplying the stored electrical energy to an charge external device.

2. The portable device of claim 1, wherein the wireless communicating means provides voice communication.

3. The portable device of claim 1, wherein the energy storage means comprises at least one of a battery and a capacitor.

4. The portable device of claim 1, wherein the port means comprises a USB compatible connector port.

5. The portable device of claim 1, further comprising a voltage regulator coupled to the power storage means to provide a standardized voltage to the port means.

6. The portable device of claim 1, further comprising a current limiting means coupled to the energy storage means to protect the portable device and the external device from damage due to an excessive current flow.

7. The portable device of claim 1, further comprising a mounting means attachable to a surface to expose the light energy converting means to a source of light energy.

8. The portable device of claim 7, wherein the surface is transparent, and the light energy converting means is configured to receive light energy through the transparent surface.

9. The portable device of claim 1, wherein the external device is at least one of a cell phone, MP3 player, portable computer, and personal digital assistant.

10. The portable device of claim 1, wherein the stored electrical energy is supplied at approximately 5 Volt and a selected maximum DC current.

11. The portable device of claim 3, further comprising a recharge port means to enable electrically recharging the electrical energy storage means as an alternative to solar recharging using the light energy converting means.

12. A portable device comprising:
a wireless communications module configured to communicate with a communication device;
a rechargeable energy storage device coupled to the wireless communications module;
a solar power cell coupled to the rechargeable energy storage device configured to charge the rechargeable power storage device; and
a port coupled to the rechargeable energy storage device configured to provide energy to charge an external device via the port.

13. The portable device of claim 12, wherein the wireless communication module provides voice communication.

14. The portable device of claim 12, wherein the rechargeable power storage device is at least one of a battery and a capacitor.

15. The portable device of claim 12, wherein the port is a USB compatible connector port.

16. The portable device of claim 12, further comprising a voltage regulator coupled to the rechargeable power storage device to provide a regulated voltage to the port.

17. The portable device of claim 12, further comprising a current limiter coupled to the rechargeable power storage device to protect at least one of the portable device and the external device from damage due to an excessive current flow.

18. The portable device of claim 12, further comprising a supporting case attachable to a surface configured to expose the solar power cell to a source of light energy.

19. The portable device of claim 18, wherein the surface is transparent, and the solar power cell is configured to receive light energy through the transparent surface.

20. The portable device of claim 17, wherein the surface comprises at least one of an automobile window and a windshield.

21. The portable device of claim 12, wherein the external device comprises at least one of a cell phone, MP3 player, portable computer, and personal digital assistant.

22. The portable device of claim 12, wherein the stored electrical energy is supplied at approximately 5 Volt and up to a selected maximum DC current.

23. The portable device of claim 12, further comprising a recharge port to enable electrically recharging the rechargeable energy storage device as an alternative to solar recharging using the solar cell.

24. A method of charging an external device from a solar powered speakerphone comprising:
connecting the external device to the solar powered speakerphone, wherein the solar powered speakerphone comprises:
a solar cell for conversion of light energy to electrical energy;
a rechargeable energy storage device coupled to the solar cell, the rechargeable energy storage device comprising at least one of a battery and a capacitor for storing the electrical energy;
a port for connecting the rechargeable energy storage device to the external device to provide the stored electrical energy to the device; and
a wireless communications module coupled to and powered by the rechargeable energy storage device, the wireless communications module configured to communicate with a communication device; and
providing energy from the rechargeable energy storage device to the external device via the port.
